(19) United States
(12) Patent Application Publication
(10) Pub. No.: US 2021/0215406 A1
(43) Pub. Date: Jul. 15, 2021

(54) AUXILIARY HEAT SOURCE, AIR CONDITIONING SYSTEM WITH AUXILIARY HEAT SOURCE, AND METHOD THEREFOR

(71) Applicant: Mitsubishi Electric US, Inc., Cypress, CA (US)

(72) Inventor: Chitose TANAKA, Wakayama-shi (JP)

(21) Appl. No.: 16/739,719

(22) Filed: Jan. 10, 2020

(51) Int. Cl. F25B 27/00; F24F 5/00; F25B 23/00; F25B 41/00; F25B 30/02; F25B 41/04; F25B 29/00

(52) U.S. Cl. CPC F25B 27/00; F24F 5/0096; F25B 23/00; F25B 41/003; F25B 2500/31; F25B 41/046; F25B 29/003; F25B 2313/0213; F25B 2500/02; F25B 30/02

(57) ABSTRACT

An air conditioning apparatus includes a first pump and a first intermediate heat exchanger connected in series, and a second pump and a second heat intermediate exchanger connected in series. A flow path switching mechanism including at least four pairs of first and second valves. The first valves select an outflow port of one of the first and second pumps, and the second valves select an inflow port of the other of the first and second pumps. A third intermediate heat exchanger operates as an auxiliary heat exchanger, and is detachably connected to one pair of first and second valves. A pipe is detachably connected to and communicating the inflow port and the outflow port of a second pair of the pairs of the first and second valves. At least one indoor heat exchanger is connected to a third pair of the first and second valves.

### TECHNICAL FIELD

The subject matter described below relates generally to an air-conditioning system using an auxiliary heat source.

### BACKGROUND

In general, an air-conditioning system circulates heat to, and from, an indoor air-conditioned space to cause the space or the like to be heated or cooled. Heat is transferred between the indoor space and the outdoor environment via an outdoor heat exchanger and an indoor heat exchanger that are connected through piping that circulates a heat medium (e.g., a refrigerant or water).

During a heating mode, the indoor unit provides heat to the indoor space. To do so, the outdoor unit absorbs heat from the outdoor ambient environment, transfers the absorbed heat to the refrigerant (e.g., by evaporating the refrigerant), and circulates the refrigerant to the indoor unit where the indoor unit releases the heat to the indoor space (e.g., by condensing the refrigerant).

During a cooling mode, the indoor unit absorbs heat from the indoor space (e.g., by evaporating the refrigerant), and circulates the refrigerant to the outdoor unit where the outdoor unit releases the heat to the outdoor ambient environment (e.g., by condensing the refrigerant).

A hybrid variable refrigerant flow (HVRF) system is known which varies the flow of refrigerant to indoor units based on demand. An HVRF system is a 2-pipe heat recovery variable refrigerant flow (VRF) system which circulates water between, for example, a Hybrid Branch Controller (HBC) and indoor units. The HVRF system comprises heat exchangers along with a refrigerant circuit that are used for heating and cooling purposes which may be simultaneous. In low ambient temperature conditions, the refrigerant circuit in the HVRF system stops working, due to some mechanical and thermodynamic problems involving the outdoor unit which is air cooled.

Heat pumps cannot operate in extremely cold conditions. The problems of performing a heating mode in a low ambient temperature environment become dramatic during very low outdoor temperature conditions, for example, at an outdoor temperature below freezing such as below about 23° F. or −5° C., or such as about −40° F. or −40° C.

It would therefore be desirable to provide an auxiliary heating source for operating a heating mode while in low ambient temperature conditions.

### SUMMARY

According to one or more embodiments, an air conditioning apparatus includes a first pump and a first intermediate heat exchanger connected in series, the first pump having an outflow port and an inflow port. Also included is a second pump and a second heat intermediate exchanger connected in series, the second pump having an outflow port and an inflow port. Also included is a flow path switching mechanism including at least four pairs of first and second valves, the first valves are configured to select the outflow port of one of the first and second pumps, and the second valves are configured to select the inflow port of the other of the first and second pumps. Also included is a third intermediate heat exchanger operating as an auxiliary heat exchanger, the third intermediate heat exchanger having an inflow port and an outflow port detachably connected to a first pair of the pairs of first and second valves. Also included is a pipe detachably connected to and communicating the inflow port and the outflow port of a second pair of the pairs of the first and second valves. Also included is an indoor heat exchanger having an outflow port and an inflow port connected to a third pair of the pairs of first and second valves.

An embodiment further includes an air-cooled outdoor unit having a refrigerant flow circuit including a compressor, a refrigerant flow switching valve, and an outdoor heat exchanger; the first heat intermediate exchanger and the second intermediate heat exchanger exchange heat in series with the refrigerant flow circuit of the outdoor unit.

In an embodiment, the outflow port of the second pump is switched by the flow path switching mechanism to communicate to the inflow port of the first pump, the outflow port of the first pump is switched by the flow path switching mechanism to communicate to the inflow port of the second pump, at least one pair of the flow path switching mechanism is connected to the indoor heat exchanger, the inflow port of the first pump is switched by the flow path switching mechanism to communicate to the outflow port of the first pump, the auxiliary heat exchanger heats a fluid flowing in a refrigeration circuit of the second pump and second intermediate heat exchanger, the compressor of the outdoor unit is stopped, and the first pump supplies the heated fluid to the indoor heat exchanger.

In an embodiment, the outdoor unit includes a fluorocarbon system fluid heat exchanger circuit, and the auxiliary heat exchanger includes a water-based heat exchanger circuit.

In an embodiment, the compressor of the outdoor unit is inverter-driven with variable output control; during a compressor stop of the compressor, a predetermined value of a water temperature difference control by a valve of the indoor unit is increased, and a pump flow rate is reduced based on a temperature difference between the water temperature of the indoor unit and the auxiliary heat exchanger.

In another embodiment, the indoor heat exchanger includes an air-conditioning water circuit, and the auxiliary heat exchanger and the air-conditioning water circuit of the indoor heat exchanger exchange heat via the first intermediate heat exchanger or the second intermediate heat exchanger.

In yet another embodiment, the at least four pairs of first and second valves, the first pump, the first intermediate heat exchanger, the second pump, and the second intermediate heat exchanger are disposed in a hybrid branch controller module.

In still another embodiment, the auxiliary heat exchanger is configured to be connected to a hot water supply circuit as an auxiliary heat source.

In a further embodiment, the auxiliary heat source is a gas boiler that provides hot water for the hot water supply circuit, which provides additional heating to the indoor heat exchanger.

In another embodiment, the indoor heat exchanger is included in an indoor unit installed in a living space in a building, and the outdoor unit is installed outside the living space.

Another embodiment is a hybrid variable refrigerant system comprising one or more, or a combination of, the above-discussed air conditioning apparatus.

Another embodiment provides a method of operating an air conditioning system including a first pump and a first intermediate heat exchanger connected in series, the first pump having an outflow port and an inflow port; a second pump and a second heat intermediate exchanger connected in series, the second pump having an outflow port and an inflow port; a flow path switching mechanism including at least four pairs of first and second valves, the first valves are configured to select the outflow port of one of the first and second pumps, and the second valves are configured to select the inflow port of the other of the first and second pumps; a third intermediate heat exchanger operating as an auxiliary heat exchanger, the third intermediate heat exchanger having an inflow port and an outflow port detachably connected to a first pair of the pairs of first and second valves; a pipe detachably connected to and communicating the inflow port and the outflow port of a second pair of the pairs of the first and second valves; and an indoor heat exchanger having an outflow port and an inflow port connected to a third pair of the pairs of first and second valves. The method may include connecting the first intermediate heat exchanger and the second intermediate heat exchanger to a refrigerant circuit. The method also may include simultaneously providing a heating operation and a cooling operation using the first intermediate heat exchanger, the first heat pump, the second intermediate heat exchanger, and the second heat pump for heating and cooling. The method also may include providing a heating operation using the first heat pump to circulate water in the refrigerant circuit to the indoor heat exchanger and the second heat pump to circulate the water to the auxiliary heat exchanger.

Another embodiment of the method further includes connecting an auxiliary heat source that heats the water and provides the water which is heated to the first pump and the second pump.

In another embodiment of the method, the auxiliary heat source is a gas boiler that provides the heated water for the refrigerant circuit.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a refrigerant circuit diagram of a known hybrid variable refrigerant flow air conditioning system.

FIG. 2 is a refrigerant circuit diagram of a hybrid variable refrigerant flow air conditioning system with auxiliary heat source according to disclosed embodiments.

FIG. 3A is a refrigerant circuit diagram of the hybrid variable refrigerant flow air conditioning system of FIG. 2 during a normal heating operation mode.

FIG. 3B is a p-h diagram for the normal heating operation mode corresponding to FIG. 3A.

FIG. 4A is a refrigerant circuit diagram of the hybrid variable refrigerant flow air conditioning system of FIG. 2 during a normal cooling operation mode.

FIG. 4B is a p-h diagram for the normal cooling operation mode corresponding to FIG. 4A.

FIG. 5A is a refrigerant circuit diagram of the hybrid variable refrigerant flow air conditioning system of FIG. 2 during a heating main mode.

FIG. 5B is a p-h diagram for the heating main mode corresponding to FIG. 5A.

FIG. 6A is a refrigerant circuit diagram of the hybrid variable refrigerant flow air conditioning system of FIG. 2 during a cooling main mode.

FIG. 6B is a p-h diagram for the cooling main mode corresponding to FIG. 6A.

FIG. 7 is a refrigerant circuit diagram of the hybrid variable refrigerant flow air conditioning system of FIG. 2 using only auxiliary heat.

FIG. 8 is a refrigerant circuit diagram of a hybrid variable refrigerant flow air conditioning system using only auxiliary heat.

FIG. 9 is an installation outline diagram of a hybrid variable refrigerant flow air conditioning system with auxiliary heat source installed in a building.

### DETAILED DESCRIPTION

### I. Introduction

In overview, the present disclosure concerns a hybrid variable refrigerant flow (HRVF) system, which varies the flow of refrigerant to the indoor units based on demand, that comprises an auxiliary heat source to tackle the problem of the malfunction of the HVRF system in low ambient temperature conditions.

More particularly, various inventive concepts and principles are embodiments in systems, devices, and methods therein which provide an auxiliary heating source for operating a heating mode while in low ambient temperature conditions. An HVRF air conditioning system includes a plurality of heat exchangers, pumps, valves, a pipe and a refrigerant circuit that is connected to the plurality of heat exchangers for heating modes including simultaneous heating and cooling. When the refrigerant circuit of the HVRF system cannot operate due to extreme cold conditions, an auxiliary heat source, such as may be provided by a boiler (for example, a natural gas boiler) is used to provide hot water for the heating purpose. One of the pumps in the HVRF system may be used to circulate water heated by the auxiliary heat source to the indoor units and the other pump is used to circulate water to the auxiliary heat source.

The instant disclosure is provided to further explain in an enabling fashion the best modes of performing one or more embodiments. The disclosure is further offered to enhance an understanding and appreciation for the inventive principles and advantages thereof, rather than to limit in any manner the embodiments.

It is further understood that the use of relational terms, such as first and second, if any, are used to distinguish one from another entity, item, or action without necessarily requiring or implying any actual such relationship or order between such entities, items or actions. Some embodiments may include a plurality of processes or steps, which can be performed in any order unless expressly and necessarily limited to a particular order (i.e., processes or steps that are not so limited may be performed in any order).

As further discussed herein below, various inventive principles and combinations thereof are advantageously employed to provide an auxiliary heating source for operating a hybrid variable refrigerant flow system in heating mode while in low ambient temperature conditions.

### II. State of the Art and Observations

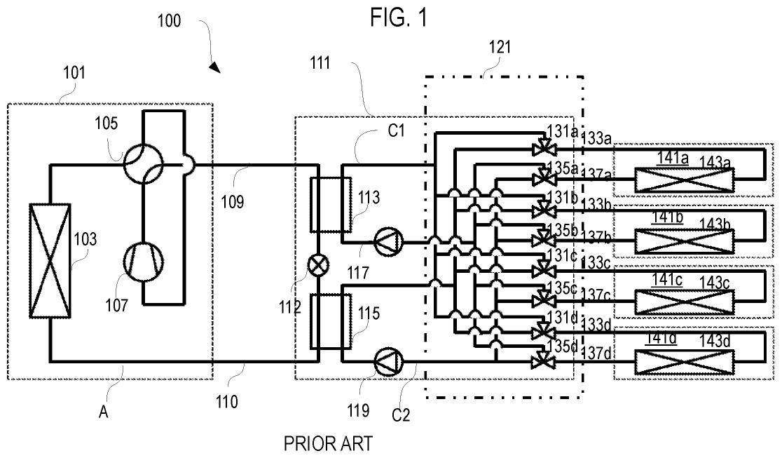

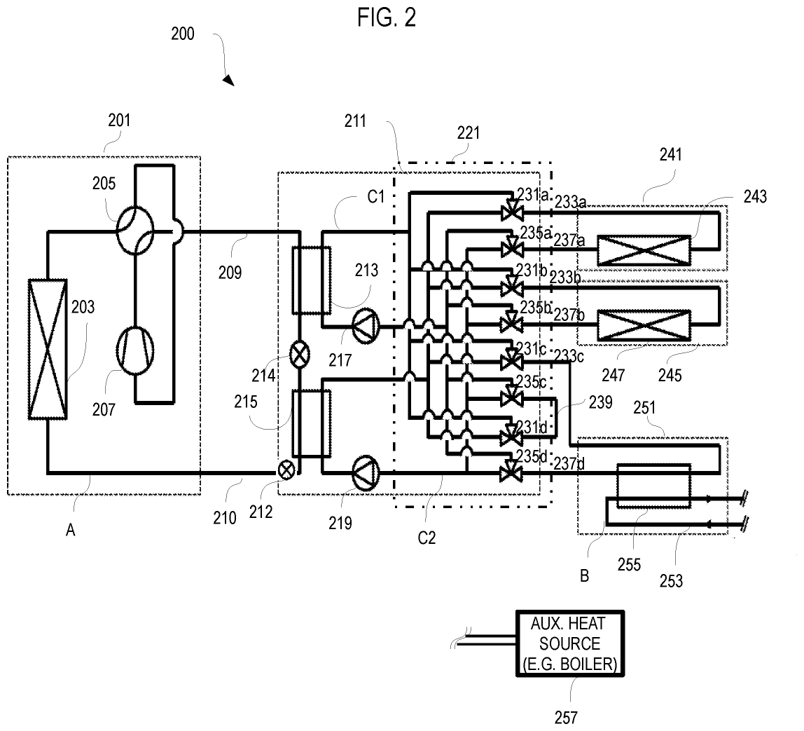

FIG. 1 is a refrigerant circuit diagram of a known air conditioning system 100, which is a hybrid variable refrigerant flow (HVRF) air conditioning system. In comparison to FIG. 2 to FIG. 9, the air conditioning system of FIG. 1 does not use auxiliary heat. An example of a known HVRF air conditioning system 100 is disclosed in more detail in US 2011/0113802 to Wakamoto et al. (herein expressly incorporated by reference as to matters discussed herein).

The air conditioning system 100 can include an outdoor unit 101, a hybrid branch controller (HBC) module 111, and indoor units 141a, 141b, 141c, 141d.

The outdoor unit 101 can include an outdoor heat exchanger 103, a refrigerant flow switching device 105, a compressor 107. The indoor units 141a, 141b, 141c, 141d each may include a respective indoor heat exchanger 143a, 143b, 143c, 143d. The indoor units may be, for example, a water indoor unit. Components of the outdoor unit 101 and the indoor units 141a-d which are well understood to those of skill in the art may be omitted from the discussion herein to avoid obscuring understanding.

The HBC module 111 may include a first intermediate heat exchanger 113, a second intermediate heat exchanger 115, a first refrigerant flow-rate controller 112, a first pump 117, a second pump 119, first valves 131a-d, second valves 135a-d, first extension pipeline 133a-d, and second extension pipeline 137 a-d. A flow path switching mechanism 121 of the HBC module 111 includes four pairs of first and second valves, each pair includes a first valve 131a-d and a second valve 135a-d. The first valve 131a-d of each pair is configured to select the outflow port of one of the first and second pumps 117, 119, and the second valves 135a-d of each pair is configured to select the inflow port of the other of the first and second pumps 117, 119.

A refrigerant flow circuit A of the outdoor unit 101 includes pipes connecting in series, in this order, the outdoor heat exchanger 103, a refrigerant flow switching device 105, a compressor 107, a first pipe 109, the first intermediate heat exchanger 113, the first refrigerant flow-rate controller 112, the second intermediate heat exchanger 115, and a second pipe 110. A heat-source side refrigerant circulating in the refrigerant flow circuit A and a use-side refrigerant circulating in a first use-side refrigeration circuit C1 are heat exchanged in the first intermediate heat exchanger 113. The heat-source side refrigerant circulating in the refrigerant flow circuit A and a use-side refrigerant circulating in a second use-side refrigeration circuit C2 are heat exchanged in the second intermediate heat exchanger 115.

The use-side refrigerant, for example, water, circulates through the first extension pipeline 131a-d, the indoor unit 141a-d, the second extension pipeline 137a-d, the one of the first and second pumps 117, 119, and the associated one of the first and second use-side refrigeration circuit C1, C2. Thus, the HVRF air conditioning system 100 circulates the use-side refrigerant such as water between, for example, an HBC 111 and indoor units; and the HVRF air conditioning system 100 circulates refrigerant between the HBC 111 and the outdoor unit 101.

The HBC module 111 may be conveniently provided as a unitary module, for example, in a housing such as a box corresponding to its dotted outline illustrated in FIG. 1. The housing of the HBC module 111 may present pairs of connection ports (in this example, four pairs of connection ports) which are configured to be connected to the first and second extension pipelines 133a-d, 137a-d respectively which connect to the indoor units 141a-d. The housing of the HBC module 111 may present two connection ports which are configured to be connected to the first and second pipes 109, 110 which connect to the outdoor unit 101. In this way, the HBC module 111 in the conventional HVRF air conditioning system 100 of FIG. 1 may be convenient to install and to be connected by the first and second pipes 109, 110 to the outdoor unit 101 and by the extension pipes 133a-d, 137a-d to the indoor units 141a-d.

However, in low to very low ambient temperature conditions, the refrigerant flow circuit A to the outdoor unit 101 of the conventional HVRF air conditioning system 100 cannot operate due to extreme cold conditions.

An example of a known heat pump and auxiliary heat source is shown for example in EP 2239513. However, the water circuit is not designed for simultaneous heating and cooling and therefore is seriously limited in application.

### III. HVRF System with Auxiliary Heat Source

Further in accordance with exemplary embodiments illustrated in FIG. 2 to FIG. 9, an HVRF system comprises an auxiliary heat source and can operate in very low ambient temperature conditions. In a situation of extreme cold conditions, the auxiliary heat source may be used to provide hot water for auxiliary heating.

The auxiliary heat source used for auxiliary heating such as during extreme low ambient temperature can be, for example, an indoor gas boiler which provides a hot water supply circuit that exchanges heat with an indoor refrigeration circuit that circulates water at an auxiliary heat exchanger to thereby increase the temperature of the refrigerant flowing to the indoor units; and the compressor of the outdoor unit is stopped.

Two pairs of the indoor unit connection ports of the hybrid branch controller (HBC) module are connected to the auxiliary heat unit. The other pairs of the indoor unit connection ports of the HBC module are connected to indoor units. Two pairs of connection ports which could be connected to indoor units in a conventional HVRF system of FIG. 1, are instead connected to the auxiliary heat unit to supply auxiliary heat. During auxiliary heat supply mode, the extension pipes and the flow path switching mechanism form the indoor refrigeration circuit that exchanges heat with (is heated by) a hot water supply circuit supplied with hot water by the auxiliary heat source such as a gas boiler; the heated water flowing in the refrigeration circuit supplies heat to the indoor units.

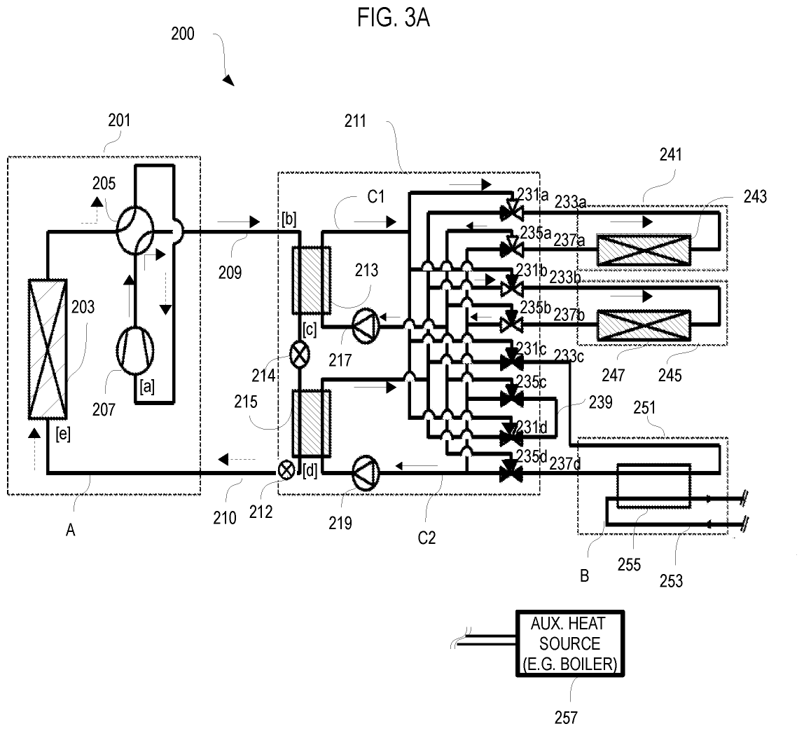

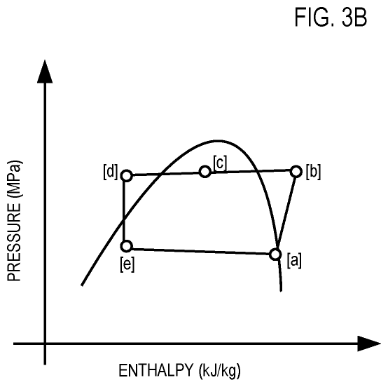

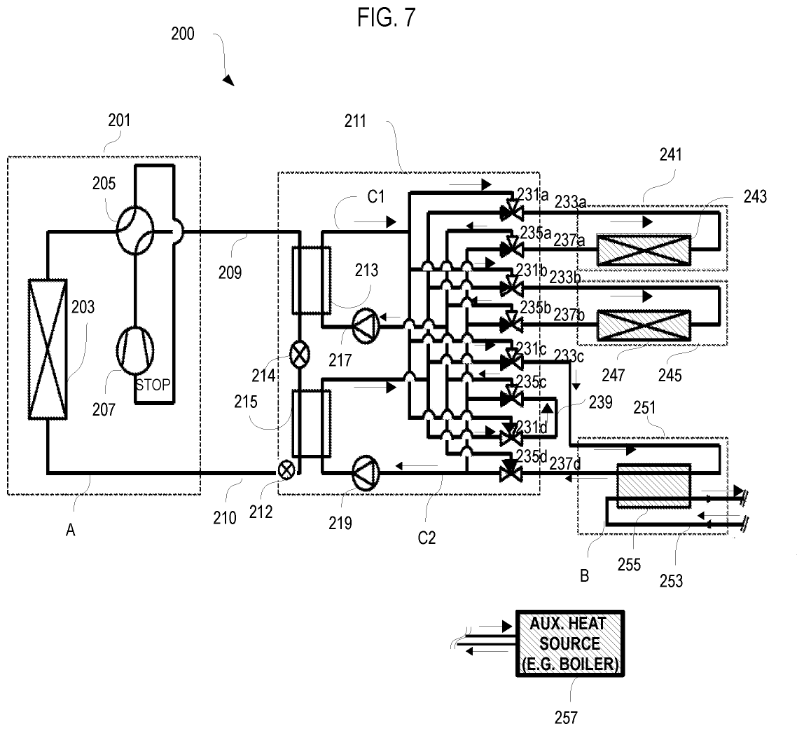

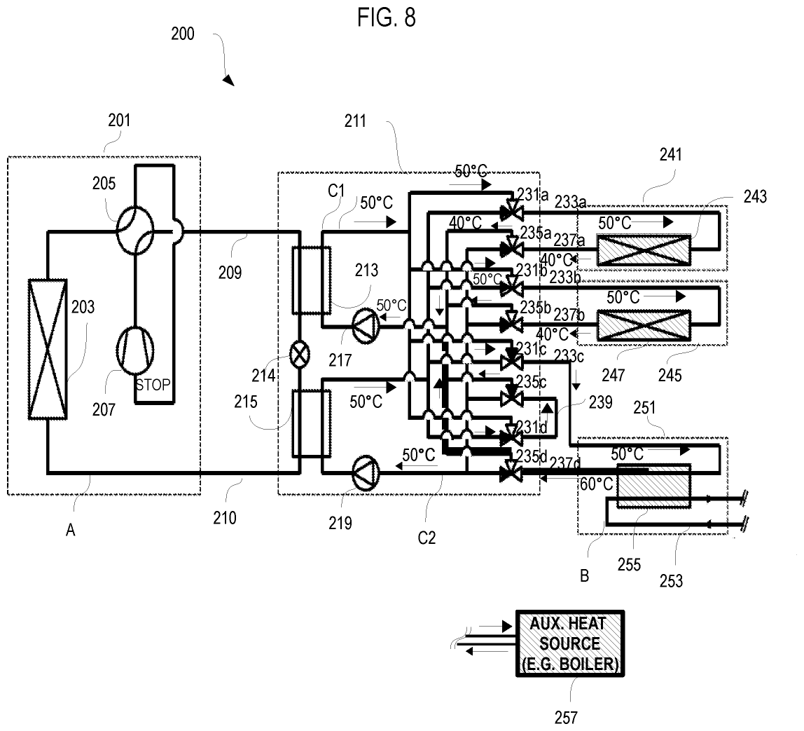

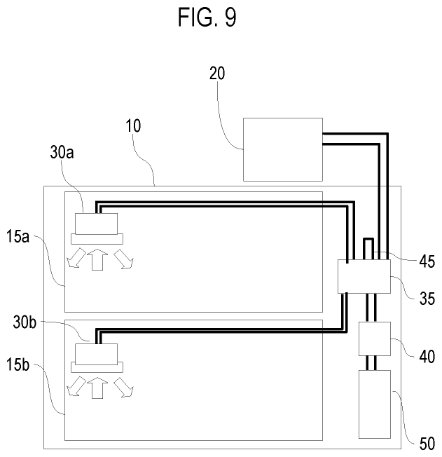

FIG. 2 illustrates an embodiment of an HVRF air conditioning system with the auxiliary heat source; FIG. 3 to FIG. 7 illustrate different operation modes of the air conditioning system of FIG. 2 including an only auxiliary heat mode (FIG. 7). FIG. 8 illustrates an HVRF air conditioning system in an only auxiliary heat mode; FIG. 9 illustrates an HVRF air conditioning system with the auxiliary heat source installed in a building.

FIG. 2 is a refrigerant circuit diagram of a hybrid variable refrigerant flow air conditioning system 200 with auxiliary heat source according to disclosed embodiments.

The air conditioning system 200 can include an outdoor unit 201, a hybrid branch controller (HBC) module 211, one or more indoor units here represented by two indoor units 241, 245, and an auxiliary heat unit 251.

The outdoor unit 201 can include an outdoor heat exchanger 203, a refrigerant flow switching device 205, and a compressor 207. The refrigerant flow switching device may be, for example, a four-way valve (for example, to switch the flow of refrigerant between the outdoor unit 201 and the indoor units 241, 245).

The indoor units 241, 245 each may include a respective indoor heat exchanger 243, 247.

The HBC module 211 may be similar to the HBC module 111 of FIG. 1. The HBC module 211 may include a first intermediate heat exchanger 213, a second intermediate heat exchanger 215, a first refrigerant flow-rate controller 212, a first pump 217, a second pump 219, a second refrigerant flow-rate controller 214, first valves 231a-d, second valves 235a-d, first extension pipelines 233a-d, and second extension pipelines 237a-d. A flow path switching mechanism 221, indicated by the double-dot-dash line, includes four pairs of first and second valves, each pair includes a first valve 231a-d and a second valve 235a-d. The valves may be, for example, 3-way valves. The flow path switching mechanism 221 is omitted from the subsequent illustrations to avoid obscuring the figures. The flow path switching mechanism 221 may include more than four pairs of first and second valves in some embodiments. The first valve 231a-d of each pair is configured to select the outflow port of one of the first and second pumps 217, 219, and the second valves 235a-d of each pair is configured to select the inflow port of the other of the first and second pumps 217, 219. The first and second refrigerant flow-rate controllers 212, 214 may be expansion valves.

A refrigerant flow circuit A of the outdoor unit 201 includes pipes connecting in series, in this order, the outdoor heat exchanger 203, refrigerant flow switching device 205, a compressor 207, a first pipe 209, the first intermediate heat exchanger 213, the second refrigerant flow-rate controller 214, the second intermediate heat exchanger 215, a first refrigerant flow-rate controller 212, and a second pipe 210. The compressor 207 may be, for example, an available inverter-driven refrigeration compressor, for example with an infinitely variable output control which can deliver output that is actually required. A heat-source side refrigerant circulating in the refrigerant flow circuit A and a use-side refrigerant circulating in a first use-side refrigeration circuit C1 are heat exchanged in the first intermediate heat exchanger 213. The heat-source side refrigerant circulating in the refrigerant flow circuit A and a use-side refrigerant circulating in a second use-side refrigeration circuit C2 are heat exchanged in the second intermediate heat exchanger 215.

The use-side refrigerant, for example, water, circulates through the first extension pipelines 233a-c, the indoor units 241, 245, the second extension pipelines 237a, b, d, the one of the first and second pumps 217, 219, and the associated one of the first and second use-side refrigeration circuit C1, C2. The first pump 217 and the second pump 219 may be inverter driven pumps. The HVRF air conditioning system 200 circulates the use-side refrigerant such as water between, for example, the HBC 211 and the indoor units 241, 245; and the HVRF air conditioning system 200 circulates heat-source side refrigerant between the HBC 211 and the outdoor unit 201.

The HBC module 211 may be conveniently provided as a unitary module, for example, in a housing such as a box corresponding to its dotted outline illustrated in FIG. 2. The HBC module 211 may be configured for use with the auxiliary heat unit 251. The housing of the HBC module 211 may present pairs of connection ports (in this example, four pairs of connection ports) which are configured to be connected to the first and second extension pipelines 233a-c, 237a, b, d respectively which connect to the indoor units 241, 245, the auxiliary heat unit 251, and a connector pipe 239. The housing of the HBC module 211 may present two connection ports which are configured to be connected to the first and second pipes 209, 210 which connect to the outdoor unit 201. In this way, the HBC module 211 may be convenient to install and to be attached/removed and connected by the first and second pipes 209, 210 to the outdoor unit 201 and detachably attached/removed and connected by the extension pipes to the indoor units and to the auxiliary heat unit 251. In some embodiments, the connection ports are configured for detachable connection so that an installer can easily attach and remove the auxiliary heat unit 251 and for detachable connection to indoor units as in FIG. 1, so that the auxiliary heat unit 251 may be easily attached to or detached from a particular installation as desired. In some installations, the HBC module 211 may be an existing HBC module such as illustrated in FIG. 1 with no structural change therein, but requiring appropriate configuration and control change as further discussed herein of the existing flow path switching mechanism and connection to the auxiliary heat unit 251 also further discussed herein. In some installations, the outdoor unit 201 may be an existing outdoor unit with no structural change therein, and may utilize an existing first pipe 209 and second pipe 210.

Because the auxiliary heat exchanger 255 is detachably connected to the HBC module 211, the HBC module does not need to always be equipped with the auxiliary heat source. By comparison, if it is necessary for a system to be connected to an auxiliary heat source, this increases the cost of the system for someone who does not require the auxiliary heat source. Moreover, it is unnecessary to manufacture two types of outdoor units or HBC modules with and without auxiliary heat exchangers which otherwise complicates development and sales.

The auxiliary heat unit 251 may include a third intermediate heat exchanger operating as an auxiliary heat exchanger 255. The auxiliary heat exchanger 255 exchanges heat with the refrigeration circuit C2 and the hot water supply circuit B. An auxiliary heat source 257 directly supplies hot water to the hot water supply circuit 253. The auxiliary heat source 257 may be a boiler, for example, a natural gas boiler, which provides hot water to the hot water supply 253 circuit. The flow rate in the refrigeration circuits C1, C2 can be adjusted because the first pump 217 and the second pump 219 can be used separately for cooling and heating. A separate pump and/or a separate control valve is not necessary to control the water flow temperature on the auxiliary heat unit side.

Consequently, heat is transferred from the auxiliary heat source 257 (for example, the gas boiler) to the HBC module 211. Accordingly, an HVRF system is provided with dramatically improved performance at low ambient temperature conditions, such as in very cold climate areas. The VRF system can use the outdoor unit 201 to provide heating during mild climate conditions and can use the auxiliary heat source (such as a natural gas boiler, e.g., a natural gas condensing boiler) to provide heating during severe weather conditions.

The air conditioning apparatus 200 is configured for a cooling operation or a heating operation to be performed at the indoor units 241, 245 on the basis of an instruction from each of the indoor units 241, 245. That is, the air conditioning apparatus 200 can be configured to perform four operation modes (the full-cooling operation mode, full-heating operation mode, the cooling main operation mode, and the heating main operation mode) discussed further below, analogous to the air-conditioner of FIG. 1. Furthermore, the HVRF system 200 with auxiliary heat source may be configured to provide heating operation mode using only auxiliary heat, which is not provided by the air-conditioning apparatus of FIG. 1, for example on the basis of an instruction from the respective indoor unit and/or on the basis of a measured outdoor ambient temperature such as at the outdoor unit.

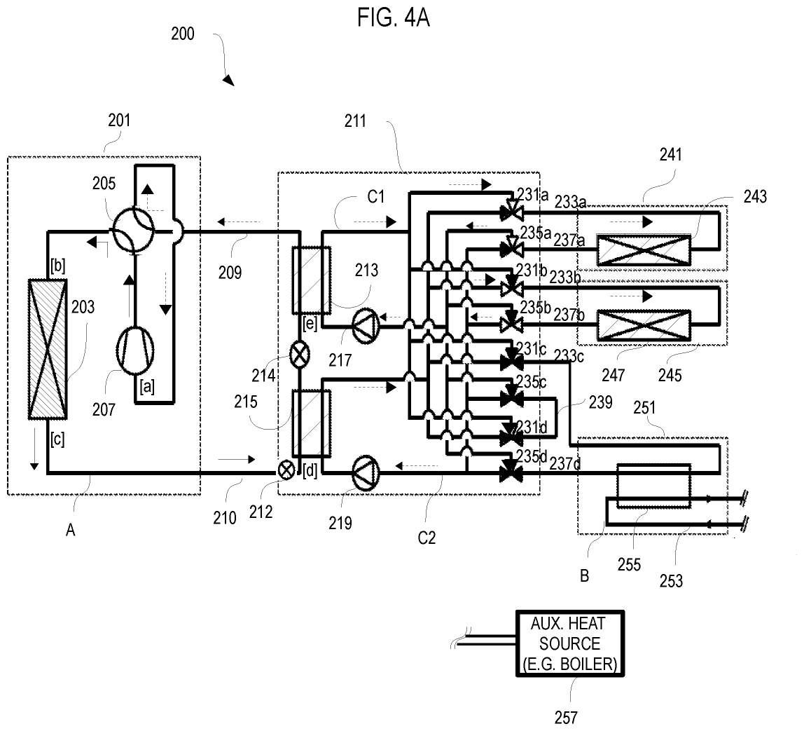

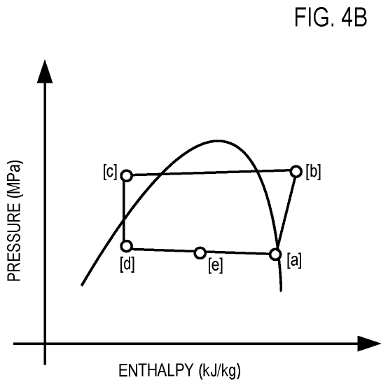

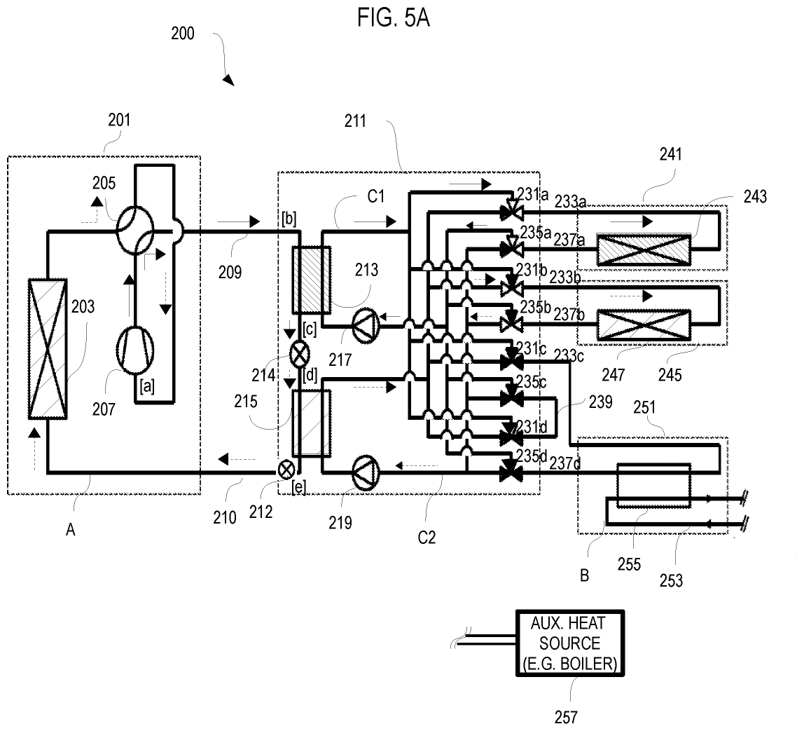

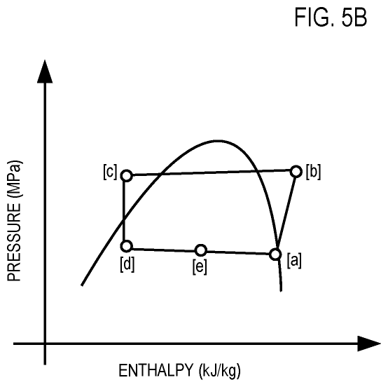

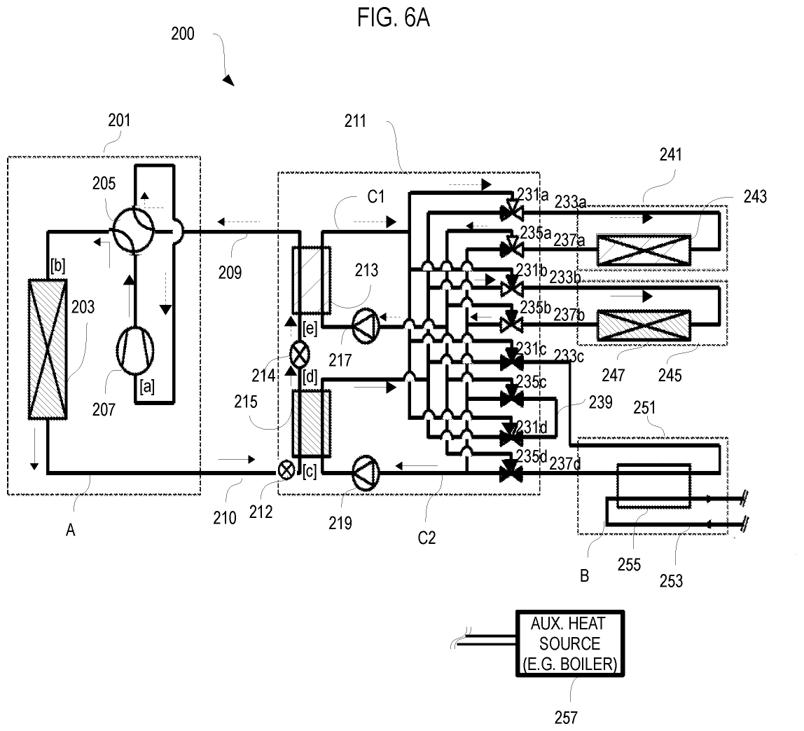

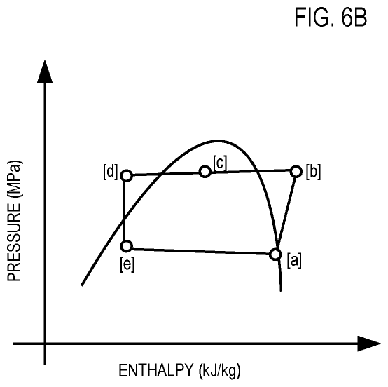

The HVRF system 200 with auxiliary heat source may provide normal heating operation mode (FIG. 3A), normal cooling operation mode (FIG. 4A), simultaneous heating and cooling in heating main mode (FIG. 5A), simultaneous heating and cooling in cooling main mode (FIG. 6A), and heating operation mode using only auxiliary heat (FIG. 7, FIG. 8). These heating and cooling modes are discussed in more detail below. In these figures, a broken line arrow indicates cooling flow, and a solid arrow indicates heating flow; wide hatching indicates cooling operation, and narrow hatching indicates heating operation.

FIG. 3A is a refrigerant circuit diagram of the hybrid variable refrigerant flow air conditioning system of FIG. 2 during a normal heating operation mode. FIG. 3B is a p-h diagram for the normal heating operation mode corresponding to FIG. 3A, illustrating a change in the heat-source side refrigerant in the normal heating operation mode. Refrigerant states of the heat-source side refrigerant at points [a] to [e] in FIG. 3A correspond to refrigerant states at [a] to [e] illustrated in FIG. 3B, respectively.

In the normal heating operation mode, the first refrigerant flow-rate controller 212 is controlled (adjusted), and the second refrigerant flow-rate controller 214 is fully open. The indoor units 241, 245 are providing heating. The auxiliary heat unit 251 is not used.

In FIG. 3B, points [a] to [b] illustrates a change of the heat-source side refrigerant which is compressed in the compressor 207. Points [b] to [c] illustrates a change in the heat-source side refrigerant which is condensed in the first intermediate heat exchanger 213 acting as a condenser. Points [c] to [d] illustrates a change in the heat-source side refrigerant which is further condensed in the second intermediate heat exchanger 215 acting as a condenser. Points [d] to [e] illustrate a change in the heat-source side refrigerant in the first refrigerant flow-rate controller 212 as the expansion device. Points [e] to [a] illustrate a change in the heat-source side refrigerant which is evaporated in the outdoor heat exchanger 203 acting as an evaporator.

FIG. 4A is a refrigerant circuit diagram of the hybrid variable refrigerant flow air conditioning system of FIG. 2 during a normal cooling operation mode. FIG. 4B is a p-h diagram for the normal cooling operation mode corresponding to FIG. 4A, illustrating a change in the heat-source side refrigerant in the normal cooling operation mode. Refrigerant states of the heat-source side refrigerant at points [a] to [e] in FIG. 4A correspond to refrigerant states at [a] to [e] illustrated in FIG. 4B, respectively.

In the normal cooling operation mode, the first refrigerant flow-rate controller 212 is controlled (adjusted), and the second refrigerant flow-rate controller 214 is fully open. The indoor units 241, 245 are providing cooling. The auxiliary heat unit 251 is not used.

In FIG. 4B, points [a] to [b] illustrates a change of the heat-source side refrigerant which is compressed in the compressor 207. Points [b] to [c] illustrates a change in the heat-source side refrigerant which is condensed in the outdoor heat exchanger 203 acting as a condenser. Points [c] to [d] illustrates a change in the heat-source side refrigerant in the first refrigerant flow-rate controller 212 acting as the expansion device. Points [d] to [e] illustrate a change in the heat-source side refrigerant which is evaporated in the second intermediate heat exchanger 215 acting as an evaporator. Points [e] to [a] illustrate a change in the heat-source side refrigerant which is further evaporated in the first intermediate heat exchanger 213 acting as an evaporator.

FIG. 5A is a refrigerant circuit diagram of the hybrid variable refrigerant flow air conditioning system of FIG. 2 during a heating main mode. FIG. 5B is a p-h diagram for the heating main mode corresponding to FIG. 5A, illustrating a change in the heat-source side refrigerant in the heating main mode. Refrigerant states of the heat-source side refrigerant at points [a] to [e] in FIG. 5A correspond to refrigerant states at [a] to [e] illustrated in FIG. 5B, respectively.

In the heating main mode, the first refrigerant flow-rate controller 212 is fully open and the second refrigerant flow-rate controller 214 is controlled (adjusted). Simultaneously, one of the indoor units 241, 245 provides heating and the other of the indoor units 241, 245 provides cooling. In the heating main mode, heating demand Qₕₑₐₜ is larger than cooling demand Q_{cool}. When in the heating main mode, the compressor 207 operates to meet the heating demand and extra cooling (=evaporating) capacity is disposed through the outdoor heat exchanger 203. The position of the refrigerant flow switching device 205 in the outdoor unit during the heating main mode is the same as in the normal heating mode (FIG. 3A). The auxiliary heat unit 251 is not used.

In FIG. 5B, point [a] to [b] illustrates a change of the heat-source side refrigerant which is compressed in the compressor 207. Points [b] to [c] illustrates a change in the heat-source side refrigerant which is condensed in the first intermediate heat exchanger 213 acting as a condenser. Points [c] to [d] illustrates a change in the heat-source side refrigerant in the second refrigerant flow rate controller 214 as an expansion valve. Points [d] to [e] illustrate a change in the heat-source side refrigerant which is evaporated in the second intermediate heat exchanger 215 acting as an evaporator. Points [e] to [a] illustrate a change in the heat-source side refrigerant which is further evaporated in the outdoor heat exchanger 203 acting as an evaporator.

FIG. 6A is a refrigerant circuit diagram of the hybrid variable refrigerant flow air conditioning system of FIG. 2 during a cooling main mode. FIG. 6B is a p-h diagram for the cooling main mode corresponding to FIG. 6A, illustrating a change in the heat-source side refrigerant in the cooling main mode. Refrigerant states of the heat-source side refrigerant at points [a] to [e] in FIG. 6A correspond to refrigerant states at [a] to [e] illustrated in FIG. 6B, respectively.

In the cooling main mode, the first refrigerant flow-rate controller 212 is fully open and the second refrigerant flow-rate controller 214 is controlled (adjusted). Simultaneously, one of the indoor units 241, 245 provides heating and the other of the indoor units 241, 245 provides cooling. In the cooling main mode, the cooling demands Q_{cool} is larger than the heating demand Qₕₑₐₜ. When in the cooling main mode, the compressor 207 operates to meet the cooling demand and extra heating (=condensing) capacity is disposed through the outdoor heat exchanger 203. The position of the refrigerant flow switching device 205 in the outdoor unit during the cooling main mode is the same as in the normal cooling mode (FIG. 4A). The auxiliary heat unit 251 is not used.

In FIG. 6B, points [a] to [b] illustrates a change of the heat-source side refrigerant which is compressed in the compressor 207. Points [b] to [c] illustrates a change in the heat-source side refrigerant which is condensed in the outdoor heat exchanger 203 acting as a condenser. Points [c] to [d] illustrates a change in the heat-source side refrigerant which is further condensed in the second intermediate heat exchanger 215 acting as a condenser. Points [d] to [e] illustrate a change in the heat-source side refrigerant which is expanded in the second refrigerant flow-rate controller 214 acting as an expansion device. Points [e] to [a] illustrate a change in the heat-source side refrigerant which is evaporated in the first intermediate heat exchanger 213 acting as an evaporator.

FIG. 7 is a refrigerant circuit diagram of the hybrid variable refrigerant flow air conditioning system of FIG. 2 using only auxiliary heat. The compressor 207 is stopped, the outdoor unit 201 is not operating, and the heat-source side refrigerant is not flowing. The auxiliary heat unit 251, the auxiliary heat exchanger 255, and the auxiliary heat source 257 are operating. The use-side refrigerant in the refrigeration circuit C2 is heated at the auxiliary heat exchanger 255 by the hot water supply circuit B which circulates a fluid, e.g., water, from the hot water supply 253 which is heated by the auxiliary heat source 257, e.g., a gas boiler. The indoor units 241, 245 are all providing heating and are connected to the auxiliary heat exchanger 255.

The first pump 217 and the first intermediate heat exchanger 213 are connected in series; the first pump 217 has an outflow port and an inflow port. The second pump 219 and the second heat intermediate exchanger 215 are connected in series; the second pump 219 has an outflow port and an inflow port.

The flow path switching mechanism 221 (outlined in the double-dot-dash line, in FIG. 2) includes at least four pairs of first and second valves 231, 235; each pair has a first valve 231a-d and a second valve 235a-d. The first valves 231a-d are set into a configuration that selects the outflow port of one of the first and second pumps 217, 219. The second valves 235a-d are configured to select the inflow port of the other of the first and second pumps 217, 219.

A third intermediate heat exchanger is provided which operates as the auxiliary heat exchanger 255. The third intermediate heat exchanger/auxiliary heat exchanger 255 has an inflow port and an outflow port. The outflow port of the auxiliary heat exchanger 255 is detachably connected to one second valve 235d of one pair of the first and second valves, and the inflow port of the auxiliary heat exchanger 255 is detachably connected to one first valve 231c of the one pair of the first and second valves.

A pipe 239 is detachably connected to and communicating the inflow port and the outflow port of a second pair of the pairs of the first and second valves 231d, 235c.

An indoor heat exchanger, here represented by indoor heat exchangers 243, 247, having an outflow port and an inflow port is connected to a third pair of the pairs of first and second valves 231a, 235a. Any additional indoor heat exchanger is connected to a respective remaining pair of the pairs of first and second valves 231b, 235b.

The first pump 217 supplies hot water to the indoor units 241, 245. The second pump 219 is fed and heated from the refrigeration circuit of the first pump to the auxiliary heat exchanger 255, and returns the hot water to the refrigeration circuit of the first pump 217. This is considered in more detail below.

In the flow path switching mechanism 221 with this configuration, refrigerant (such as water) is circulated in the refrigeration circuit C1, C2 and heated by the auxiliary heat unit 251; cooled refrigerant in the refrigeration circuit C1, C2 which flowed out of the indoor heat exchangers 243, 247 is mixed with and warmed by the heated refrigerant from the auxiliary heat unit 251; the now warmed refrigerant is pumped by the first pump 217 to the first intermediate heat exchanger 213 and then supplied to the indoor heat exchangers 243, 247 and to the pipe 239 which circulates back into the flow path switching mechanism 221 of the hybrid branch controller 211; the pipe 239 supplies the warmed refrigerant to the second pump 219 and then the warmed refrigerant is supplied to the second intermediate heat exchanger 215 and then to the auxiliary heat exchanger 255 in the auxiliary heat unit 251 to be heated.

While the compressor is stopped and the auxiliary heat exchanger is in use, the set value of the water temperature difference control of the valve of the indoor unit can be expanded. Gas used by the auxiliary heat source (e.g., a gas boiler) 257 to heat the hot water supply 253 can be heated at a high temperature, and the pump flow rate can be reduced because of the high temperature difference, resulting in energy saving by reducing pump power.

FIG. 8 is a refrigerant circuit diagram of a hybrid variable refrigerant flow air conditioning system using only auxiliary heat, and generally corresponds to FIG. 7. FIG. 8 illustrates example temperatures. Refrigerant flowing in the first refrigeration circuit C1 upstream of the indoor heat exchangers 243, 247 may be at 50° C. Heat is exchanged by the indoor heat exchangers 243, 247 to warm a living space in which the indoor units 241, 245 are located. Refrigerant flowing in the first refrigeration circuit C1 as it exits the indoor heat exchangers 243, 247 has been cooled, for example to 40° C. Refrigerant flowing in the second refrigeration circuit C2 upstream of the auxiliary heat exchanger 255 may be at 50° C. Heat is exchanged between the hot water supply 253 and the second refrigeration circuit C2 at the auxiliary heat exchanger 255, and refrigerant flowing in the second refrigeration circuit C2 as it exits the auxiliary heat exchanger 255 has been heated, for example to 60° C. (60° C. is shown in FIG. 8 by extra heavy black lines).

Refrigerant (such as water) is circulated in the refrigeration circuit C1, C2 and heated by the auxiliary heat unit 251; cooled refrigerant in the refrigeration circuit C1, C2 which flowed out of the indoor heat exchangers 243, 247 at a temperature of, for example, 40° C., is mixed with the heated refrigerant from the auxiliary heat unit 251 which is at a temperature of, for example, 60° C. and warmed to a temperature of, for example, 50° C. The warmed refrigerant at a temperature of, for example, 50° C. is pumped by the first pump 217 to the first intermediate heat exchanger 213 and then supplied to the indoor heat exchangers 243, 247 and to the pipe 239 which loops back into the flow path switching mechanism 221 of the hybrid branch controller 211; the pipe 239 supplies the warmed refrigerant at a temperature of, for example, 50° C. to the second pump 219 and then the warmed refrigerant is supplied to the second intermediate heat exchanger 215 and then to the auxiliary heat exchanger 255 in the auxiliary heat unit 251 to be heated to, for example, 60° C. It should be understood that these temperatures are examples used to illustrate the principles of the heating by the auxiliary heat unit 251; other embodiments may use other temperatures so long as the auxiliary heat unit 251 provides auxiliary heat.

FIG. 9 is an installation outline diagram of a hybrid variable refrigerant flow (HVRF) air conditioning system with auxiliary heat source installed in a building 10. The HVRF air conditioning system includes an outdoor unit 20 outside of the building 10, for example on a roof top. Inside the building, the HVRF air conditioning system includes indoor unit(s) (here represented by two indoor units 30a, 30b), and hybrid branch controller (HBC) module 35. One or more of the indoor units 30a, 30b may be disposed in each of one or more living spaces 15a, 15b included in the building 10. The refrigeration circuits of indoor units 15a, 15b are connected to the HBC module 35 and may exchange heat with the refrigerant flow circuit of the outdoor unit 20 through the HBC module 35 using conventional techniques for normal heating operation mode, normal cooling operation mode. The HVRF air conditioning system is provided with an auxiliary heat unit 40, and hot water supply as an example auxiliary heat source 50, and pipe 45 connected to the HBC module, as further discussed in the above FIG. 2 to FIG. 8. The hot water supply 50 may be, for example, a conventional gas boiler. The auxiliary heat unit 40 and the hot water supply 50 may be located inside the building 10 and may use water in the hot water supply circuit. The HBC module 35 is configured appropriately for use with the auxiliary heat unit 40 for example as discussed in connection with the above FIG. 2 to FIG. 8 so as to provide auxiliary heat. In the heating operation mode using only auxiliary heat for example during extremely low ambient temperature conditions, the outdoor unit 20 is stopped and the hot water supply circuit supplied with hot water from the hot water supply 50 (e.g., a boiler) heats water in the refrigeration circuit at the auxiliary heat unit 40 with the auxiliary heat exchanger.

Because the auxiliary heat source 257 can be connected to a household hot water supply, safety is improved and contaminants are reduced on the refrigeration circuit C1, C2 side of the air conditioning system.

The HVRF air conditioning system can use refrigerant between the outdoor unit and the HBC, and water between the HBC and the indoor units. That is, water can be used as the refrigerant for heating and cooling in the living spaces. In particular, the outdoor unit 201 may utilize a fluorocarbon system fluid in the refrigerant flow circuit A. The hot water supply circuit B of the auxiliary heat exchanger 255, and the refrigeration circuits C1, C2 of the indoor units 241, 245 may be limited to water alone or with antifreeze. The reduced consumption of fluorocarbon system fluid or non-water refrigerant reduces the environmental impact of the system and enhances safety by preventing leakage of fluorocarbon system fluid or non-water refrigerant into the living spaces by the indoor units and auxiliary heater.

This disclosure is intended to explain how to fashion and use various embodiments in accordance with, not limit. the true, intended, and fair scope and spirit thereof. The foregoing description is not intended to be exhaustive, or limited to, the precise form disclosed. Modifications or variations are possible in light of the above teachings. The embodiments above are chosen and described to provide illustration of the principles as practical applications, and to enable one of ordinary skill in the art to utilize the various embodiments and with various modifications as are suited to the particular use contemplated. All such modifications and variations are within the scope of the disclosure as determined by the appended claims, as may be amended during the pendency of this application for patent, and all equivalents thereof, when interpreted in accordance with the breadth to which they are fairly, legally, and equitably entitled.

1. An air conditioning apparatus comprising:
a first pump and a first intermediate heat exchanger connected in series, the first pump having an outflow port and an inflow port;
a second pump and a second heat intermediate exchanger connected in series, the second pump having an outflow port and an inflow port;
a flow path switching mechanism including at least four pairs of first and second valves, the first valves are configured to select the outflow port of one of the first and second pumps, and the second valves are configured to select the inflow port of the other of the first and second pumps;
a third intermediate heat exchanger operating as an auxiliary heat exchanger, the third intermediate heat exchanger having an inflow port and an outflow port detachably connected to a first pair of the pairs of first and second valves;
a pipe detachably connected to and communicating the inflow port and the outflow port of a second pair of the pairs of the first and second valves; and
an indoor heat exchanger having an outflow port and an inflow port connected to a third pair of the pairs of first and second valves.

2. The air conditioning apparatus of claim 1, further comprising
an air-cooled outdoor unit having a refrigerant flow circuit including a compressor, a refrigerant flow switching valve, and an outdoor heat exchanger,
wherein the first heat intermediate exchanger and the second intermediate heat exchanger exchange heat in series with the refrigerant flow circuit of the outdoor unit.

3. The air conditioning apparatus of claim 2, wherein
the outflow port of the second pump is switched by the flow path switching mechanism to communicate to the inflow port of the first pump,
the outflow port of the first pump is switched by the flow path switching mechanism to communicate to the inflow port of the second pump,
at least one pair of the flow path switching mechanism is connected to the indoor heat exchanger,
the inflow port of the first pump is switched by the flow path switching mechanism to communicate to the outflow port of the first pump,
the auxiliary heat exchanger heats a fluid flowing in a refrigeration circuit of the second pump and second intermediate heat exchanger,
the compressor of the outdoor unit is stopped, and
the first pump supplies the heated fluid to the indoor heat exchanger.

4. The air conditioning apparatus of claim 2, wherein
the outdoor unit includes a fluorocarbon system fluid heat exchanger circuit, and
the auxiliary heat exchanger includes a water-based heat exchanger circuit.

5. The air conditioning apparatus of claim 2,
wherein the compressor of the outdoor unit is inverter-driven with variable output control,
during a compressor stop of the compressor, a predetermined value of a water temperature difference control by a valve of the indoor unit is increased, and a pump flow rate is reduced based on a temperature difference between the water temperature of the indoor unit and the auxiliary heat exchanger.

6. The air conditioning apparatus of claim 1, wherein
the indoor heat exchanger includes an air-conditioning water circuit,
the auxiliary heat exchanger and the air-conditioning water circuit of the indoor heat exchanger exchange heat via the first intermediate heat exchanger or the second intermediate heat exchanger.

7. The air conditioning apparatus of claim 1, wherein
the at least four pairs of first and second valves, the first pump, the first intermediate heat exchanger, the second pump, and the second intermediate heat exchanger are disposed in a hybrid branch controller module.

8. The air conditioning apparatus of claim 1, wherein the auxiliary heat exchanger is configured to be connected to a hot water supply circuit as an auxiliary heat source.

9. The air conditioning apparatus of claim 8, wherein the auxiliary heat source is a gas boiler that provides hot water for the hot water supply circuit, which provides additional heating to the indoor heat exchanger.

10. The air conditioning apparatus of claim 2, wherein
the indoor heat exchanger is included in an indoor unit installed in a living space in a building,
the outdoor unit is installed outside the living space.

11. A hybrid variable refrigerant system comprising the air conditioning apparatus of claim 1.

12. A method of operating an air conditioning system including a first pump and a first intermediate heat exchanger connected in series, the first pump having an outflow port and an inflow port; a second pump and a second heat intermediate exchanger connected in series, the second pump having an outflow port and an inflow port; a flow path switching mechanism including at least four pairs of first and second valves, the first valves are configured to select the outflow port of one of the first and second pumps, and the second valves are configured to select the inflow port of the other of the first and second pumps; a third intermediate heat exchanger operating as an auxiliary heat exchanger, the third intermediate heat exchanger having an inflow port and an outflow port detachably connected to a first pair of the pairs of first and second valves; a pipe detachably connected to and communicating the inflow port and the outflow port of a second pair of the pairs of the first and second valves; and an indoor heat exchanger having an outflow port and an inflow port connected to a third pair of the pairs of first and second valves, the method comprising:
connecting the first intermediate heat exchanger and the second intermediate heat exchanger to a refrigerant circuit;
simultaneously providing a heating operation and a cooling operation using the first intermediate heat exchanger, the first heat pump, the second intermediate heat exchanger, and the second heat pump for heating and cooling; and
providing a heating operation using the first heat pump to circulate water in the refrigerant circuit to the indoor heat exchanger and the second heat pump to circulate the water to the auxiliary heat exchanger.

13. The method of claim 12, further comprising connecting an auxiliary heat source that heats the water and provides the water which is heated to the first pump and the second pump.

14. The method of claim 13, wherein the auxiliary heat source is a gas boiler that provides the heated water for the refrigerant circuit.
